(19) United States
(12) Patent Application Publication
(10) Pub. No.: US 2011/0311688 A1
(43) Pub. Date: Dec. 22, 2011

(54) PACKAGE COMPRISING ON-DEMAND COLLAPSIBLE SUPPORT MEMBER

(75) Inventors: Michael L. Becraft, Greer, SC (US); Joseph E. Owensby, Spartanburg, SC (US); Blake E. Coates, Moore, SC (US); Donald Keith Moore, JR., Spartanburg, SC (US); Amy T. Hunter, Greenville, SC (US)

(73) Assignee: CRYOVAC, INC., Duncan, SC (US)

(21) Appl. No.: 12/820,513

(22) Filed: Jun. 22, 2010

(51) Int. Cl. B65B 25/00; A23B 4/00; B65B 7/00; B65D 85/00

(52) U.S. Cl. 426/111; 426/106; 426/129; 426/413

(57) ABSTRACT

The presently disclosed subject matter relates to packaging for products (such as fresh red meat) that are enclosed between a support member and a film in such a manner that the film can be peelably removed from the support member. More specifically, the presently disclosed subject matter relates to packaging wherein the support member is collapsible to allow the product to contact the film at any desired time, such as the time of retail display.

### FIELD OF THE INVENTION

The presently disclosed subject matter relates to packaging for products (such as fresh red meat) that are enclosed between a support member and a lid (i.e., a film). More specifically, the presently disclosed subject matter relates to packaging wherein the support member is collapsible to allow the product to contact the lid at any desired time, such as at the time of retail display.

### BACKGROUND

Historically, large cuts of meat have been butchered and packaged in supermarkets, which has long been recognized to be inefficient and expensive. It is instead more beneficial to butcher and package the meat at a central processing facility that benefits from economies of scale, and then ship the packaged meat to individual supermarkets or other retail outlets. It is believed that central processing of meat would also lead to a higher quality and more sanitary product with a longer shelf-life compared to meat that is butchered and packaged in individual supermarkets.

Fresh red meat presents a particular challenge to the concept of centralized processing and packaging due to its oxygen-sensitivity as manifested primarily in the shelf-life and appearance (color) of a packaged meat product. For example, while a low-oxygen packaging environment generally increases the shelf-life of a packaged meat product, red meat has a tendency to assume a purple color when packaged in the absence of oxygen or in an environment having a very low oxygen concentration, i.e., below about 1% oxygen. Unfortunately, such a purple color is undesirable to most consumers, and marketing efforts to teach consumers about the acceptability of the purple color have been largely ineffective. When meat is exposed to a sufficiently high concentration of oxygen, e.g., as found in ambient air, it assumes a bright red color that most consumers associate with freshness. After 1 to 3 days of such exposure, however, meat assumes a brown color that is undesirable to most consumers and indicates that the meat is beginning to spoil.

A variety of packages, known as “case-ready packages,” have been developed in an effort to overcome the foregoing challenges. One type of case-ready package is a peelable “vacuum-skin” package (“peelable VSP”). A traditional peelable VSP includes a lid formed from a laminate that separates into gas-permeable and gas-impermeable portions and encloses a packaged meat product that is disposed on a support member. Similar to a peelable VSP, a peelable modified-atmosphere package (“peelable MAP”) includes a lid formed from a laminate. The laminate separates into gas-permeable and gas-impermeable portions and encloses a meat product that is disposed within a support member having a peripheral flange to which the lid is secured. Prior to securing the lid to the support member, ambient air is evacuated from the interior of the support member and replaced by a gas that extends the shelf life of the packaged product. The gas-impermeable portion of the lid is peelably removed prior to retail display so that the packaged product is displayed in a state of re-bloom. See, for example, U.S. Pat. No. 6,739,113 to Kocher et al. and U.S. Pat. No. 6,670,023 to Mueller.

While peelable VSP and MAP case-ready packages have been and continue to be successful, there is always a need and desire for improvements. To this end, the presently disclosed package enables the initial distribution and storage of fresh red meat without meat-to-film contact, followed by display of the meat with meat-to-film contact. The resulting package has an appearance similar in likeness to conventional store overwrapped packages, but without the need for additional packaging materials required by prior art packages. In addition, the delay of meat-to-film contact until the time of display significantly improves the appearance of the packaged meat products.

### SUMMARY

In some embodiments, the presently disclosed subject matter is directed to a method of inducing the bloom of a product on demand. The method comprises providing a package comprising a) a support member comprising side walls, a base for supporting a product, and a collapsing mechanism and b) a lid. In addition, the method comprises placing a product on the base and bonding the lid to the support member. A collapsing mechanism is initiated to provide product-to-film contact on demand, wherein the product-to-film contact enables the product to bloom.

In some embodiments, the presently disclosed subject matter is directed to a method of inducing product-to-film contact in a packaged product. The method comprises providing a package comprising a) a support member comprising side walls, a base for supporting a product, and a collapsing mechanism; and b) a lid. The method also comprises placing a product on the base and bonding the lid to the support member. In addition, the method also comprises initiating the collapsing mechanism to provide product-to-film contact on demand, wherein the product blooms in response to the product-to-film contact.

In some embodiments, the presently disclosed subject matter is directed to a package that enables the on demand blooming of a product. The package comprises a) a support member comprising side walls, a base for supporting a product, and a collapsing mechanism; and b) a lid. In some embodiments, initiating the collapsing mechanism provides product-to-film contact on demand, and the product-to-film contact enables the product to bloom.

### BRIEF DESCRIPTION OF THE DRAWINGS

FIG. 1a is a perspective view of one embodiment of a package of the presently disclosed subject matter in uncollapsed condition.

FIG. 1b is a fragmentary sectional view taken along the line 1b-1b in FIG. 1a.

FIG. 1c is a perspective view of one embodiment of a package of the presently disclosed subject matter in collapsed condition.

FIG. 1d is a fragmentary sectional view taken along the line 1d-1d in FIG. 1c.

FIG. 2 is a perspective view of one embodiment of a support member of the disclosed package.

FIGS. 3a-3c are enlarged fragmentary views of several embodiments of a support member of the disclosed package.

FIG. 4a is a perspective view of one embodiment of a support member of the disclosed package.

FIG. 4b is a fragmentary sectional view of one embodiment of a support member taken along the line 4b-4b in FIG. 4a.

FIG. 5a is a perspective view of one embodiment of the disclosed package enclosed within a barrier bag.

FIG. 5b is a perspective view of one embodiment of the disclosed package enclosed within a barrier overwrap.

FIG. 6a is a perspective view of one embodiment of the disclosed package.

FIG. 6b is a fragmentary sectional view of one embodiment of the disclosed package taken along line 6b-6b in FIG. 6a.

FIG. 6c is a fragmentary sectional view of one embodiment of the package of FIG. 6b while collapsing.

FIG. 6d is a fragmentary sectional view of one embodiment of the package of FIG. 6b in collapsed form.

FIG. 7a is a perspective view of one embodiment of the disclosed package.

FIG. 7b is a fragmentary sectional view of one embodiment of the disclosed package taken along line 7b-7b in FIG. 7a.

FIG. 7c is a fragmentary sectional view of one embodiment of the package of FIG. 7b while collapsing.

FIG. 7d is a fragmentary sectional view of one embodiment of the package of FIG. 7b in collapsed form.

FIG. 8a is a perspective view of one embodiment of the disclosed package.

FIG. 8b is a fragmentary sectional view of one embodiment of the disclosed package taken along line 8b-8b in FIG. 8a.

FIG. 8c is one embodiment of the package of FIG. 8b during collapse.

FIG. 8d is one embodiment of the package of FIG. 8b after collapse.

FIG. 9a is a perspective view of one embodiment of the disclosed package comprising a vent.

FIG. 9b is a fragmentary sectional view of one embodiment of the disclosed package taken along line 9b-9b in FIG. 9a.

FIG. 9c is one embodiment of the package of FIG. 9b with the vent exposed.

FIGS. 10a and 10b are perspective views of alternate embodiments of the disclosed package comprising punctures.

FIG. 11 is a perspective view of one embodiment of the disclosed package during opening.

### DETAILED DESCRIPTION

### I. General Considerations

The presently disclosed subject matter will be described more fully hereinafter with reference to the accompanying drawings in which some (but not all) embodiments are shown. Indeed, the presently disclosed subject matter can be embodied in many different forms and should not be construed as limited to the embodiments set forth herein. Rather, the disclosed embodiments are provided so that the instant disclosure will satisfy applicable legal requirements. Like numbers refer to like elements throughout.

The presently disclosed subject matter relates to packaging for products (such as fresh red meat) that are enclosed between a support member and a lid (which can be a film) in such a manner that the lid can be peelably removed from the support member. More specifically, the presently disclosed subject matter relates to packaging wherein the support member is collapsible to allow the product to contact the lid at any desired time, such as the time of retail display.

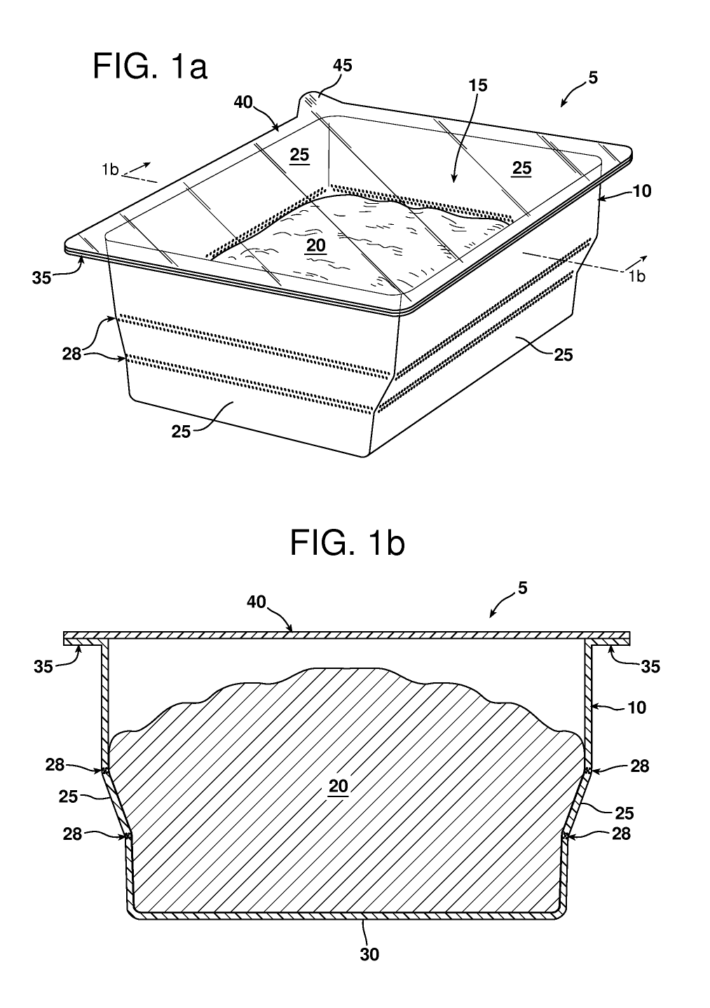

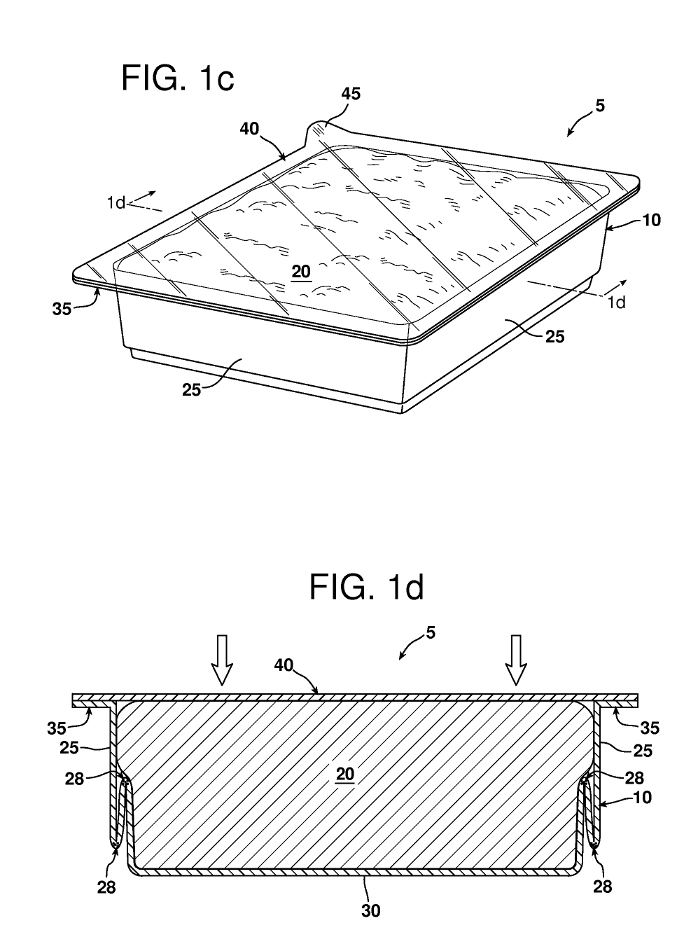

FIGS. 1a and 1b illustrate one embodiment of package 5 prior to collapse of the support member. Particularly, package 5 comprises product support member 10 having cavity 15 formed therein where product 20 can be disposed. In some embodiments, support member 10 is in the form of a tray having side walls 25 and base 30 that define cavity 15. In some embodiments, support member 10 further includes peripheral flange 35 extending outwardly from the cavity. A lid, which in some embodiments can be film 40, is bonded to flange 35 to enclose product 20 between the support member and the film. In some embodiments, film 40 is bonded to flange 35 via heat-seal or adhesives that extend substantially continuously around the upper surface of the flange to enclose the product within cavity 15. Support member 10 also comprises a collapsing mechanism (such as but not limited to hinge line 28) that enables side walls 25 to collapse, as set forth in more detail herein below. As illustrated in FIG. 1b, in some embodiments, there is no contact between film 40 and product 20 prior to the collapse of support member 10.

FIGS. 1c and 1d illustrate package 5 after collapse of support member 10. Particularly, at a desired time (such as at the time of retail display) a user can apply pressure to flange 35 to collapse support member 10 and thus reduce the overall height of support member sidewalls 25. The collapsed package then allows for film-to-product contact, thereby producing an appearance similar to a store over-wrapped package. As discussed in detail herein below, in some embodiments package 15 can comprise perforations or a venting means to promote collapsing of cavity 15. In embodiments wherein package 20 is fresh red meat, delaying the film-to-product contact results in better preservation of meat color, reduced production of purge, and improved appearance of freshness compared to prior art packages.

### II. Definitions

While the following terms are believed to be understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” can refer to “one or more” when used in the subject specification, including the claims. Thus, for example, reference to “a package” includes a plurality of such packages, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, or percentage can encompass variations of, in some embodiments ±20%, in some embodiments ±10%, in some embodiments ±5%, in some embodiments ±1%, in some embodiments ±0.5%, and in some embodiments to ±0.1%, from the specified amount, as such variations are appropriate in the disclosed system and methods.

As used herein, the phrase “abuse layer” refers to an outer film layer and/or an inner film layer, so long as the film layer serves to resist abrasion, puncture, and other potential causes of reduction of package integrity, as well as potential causes of reduction of package appearance quality. An abuse layer can comprise any polymer, so long as the polymer contributes to achieving an integrity goal and/or an appearance goal. In some embodiments, an abuse layer can comprise polymers having a modulus of at least 10⁷ Pascals at room temperature. In some embodiments, an abuse layer can comprise (but is not limited to) polyamide and/or ethylene/propylene copolymer, polypropylene; in some embodiments, nylon 6, nylon 6/6, and/or amorphous nylon.

The term “bloom” refers to the bright fresh appearance on the surface of a product. For example, in embodiments wherein the product is fresh red meat, the term “bloom” can refer to a bright red color.

The term “bulk layer” as used herein refers to a layer used to increase the abuse-resistance, toughness, modulus, etc., of a film. In some embodiments, the bulk layer can comprise polyolefin, including but not limited to at least one member selected from the group comprising: ethylene/alpha-olefin copolymer, ethylene/alpha-olefin copolymer plastomer, low density polyethylene, and/or linear low density polyethylene and polyethylene vinyl acetate copolymers.

The term “case ready” refers to an article that is pre-packaged and/or labeled at a centralized location and delivered to a retail market in a format whereby it is ready for immediate display and sale. A case ready article actively extends the quality life of a product (for example, a fresh meat product) to allow for the extra time that it takes to be packaged at a centrally located facility, distributed to the retail market, and then displayed for consumer selection and purchase.

As used herein, the phrase “easy open” refers to any means for accessing the contents of an article that obviates the need to cut and/or pierce the article with a knife, scissors, or any other sharp implement. An easy open feature can be in at least one portion of the web used to form an article and can include one or more cuts, notches, or surface-roughened areas, lines of structural weakness, or combinations thereof. Examples of such easy open features are described in U.S. Patent Application Publication Nos. 2005/0084636 to Papenfuss et al. and 2005/0254731 to Berbert et al., both of which are incorporated herein in their entireties. In some embodiments, the easy open feature can include one or more frangible or peelable layers adapted to manually separate or delaminate at least a portion of the web used to form the article, as described in U.S. Reissued Pat. No. RE37,171 to Busche et al., which is incorporated by reference herein in its entirety. It will be appreciated that in some embodiments peelable webs can further comprise one or more reclosable peelable layers. Examples of still other alternative easy open features include reclosable interlocking fasteners attached to at least a portion of the web used to form the article. Reclosable fasteners, in general, are known and are taught, for example, in U.S. Pat. Nos. 5,063,644; 5,301,394; 5,442,837; 5,964,532; 6,409,384; 6,439,770; 6,524,002; 6,527,444; 6,609,827; 6,616,333; 6,632,021; 6,663,283; 6,666,580; 6,679,027; and U.S. Patent Application Nos. 2002/0097923; and 2002/0196987, all hereby incorporated by reference in their entireties.

As used herein, the term “film” includes, but is not limited to, a laminate, sheet, web, coating, and/or the like, that can be used to package a product. The film can be rigid, semi-rigid, or flexible.

The term “meat” refers to any myoglobin-containing or hemoglobin-containing tissue from an animal, such as beef, pork, veal, lamb, mutton, chicken or turkey; and game such as venison, quail, and duck. The meat can be in a variety of forms including primal cuts, subprimal cuts, and/or retail cuts as well as ground, comminuted, or mixed. The meat or meat product is preferably fresh, raw, uncooked meat, but can also be frozen, hard chilled, or thawed. In some embodiments, the meat can be subjected to other irradiative, biological, chemical and/or physical treatments. The suitability of any particular such treatment can be determined without undue experimentation in view of the present disclosure.

As used herein, the term “on demand” refers to the ability to allow a user to initiate a particular feature at any desired time. Thus, for example, as used herein, “on demand collapsing” refers to the ability of a user to initiate collapse of a support member at any desired time.

As used herein, the term “oxygen-impermeable,” or “barrier” and the phrase “oxygen-impermeable layer” or “barrier layer,” as applied to films and/or layers, is used with reference to the ability of a film or layer to serve as a barrier to one or more gases (i.e., gaseous O₂). Such barrier materials can include (but are not limited to) ethylene/vinyl alcohol copolymer, polyvinyl alcohol homopolymer, polyvinyl chloride, homopolymer and copolymer of polyvinylidene chloride, polyalkylene carbonate, polyamide, polyethylene naphthalate, polyester, polyacrylonitrile, homopolymer and copolymer, liquid crystal polymer, SiOx, carbon, metal, metal oxide, and the like, as known to those of ordinary skill in the art. In some embodiments, the oxygen-impermeable film has an oxygen transmission rate of no more than 100 cc O₂/m²·day·atm; in some embodiments, less than 50 cc O₂/m²·day·atm; in some embodiments, less than 25 cc O₂/m²·day·atm; in some embodiments, less than 10 cc O₂/m²·day·atm; in some embodiments, less than 5 cc O₂/m²·day·atm; and in some embodiments, less than 1 cc O₂/m²·day·atm (tested at 1 mil thick and at 25° C. in accordance with ASTM D3985).

As used herein, the term “oxygen-permeable” as applied to films and/or layers refers to a film packaging material that can permit the transfer of oxygen from the exterior of the film (i.e., the side of the film not in contact with the packaged product) to the interior of the film (i.e., the side of the film in contact with the packaged product). In some embodiments, “oxygen-permeable” can refer to films or layers that have a gas (e.g., oxygen) transmission rate of at least about 1,000 cc/m²/24 hrs/atm at 73° F.; in some embodiments, at least about 5,000 cc/m²/24 hrs/atm at 73° F.; in some embodiments, at least about 10,000 cc/m²/24 hrs/atm at 73° F.; in some embodiments, at least about 50,000 cc/m²/24 hrs/atm at 73° F.; and in some embodiments, at least about 100,000 cc/m²/24 hrs/atm at 73° F. The term “permeable” can also refer to films that do not have such high gas permeability, but that are sufficiently permeable to affect a sufficiently rapid bloom for the particular product and particular end-use application.

As used herein, the term “oxygen scavenger” or “oxygen scavenging material” refers to a composition, article, or the like that consumes, depletes, or reduces the amount of oxygen from a given environment. Oxygen scavengers that can be used in the presently disclosed subject matter are disclosed in U.S. Pat. Nos. 5,310,497; 5,350,622; and 5,399,289 to Speer et al., and a method of initiating oxygen scavenging generally is disclosed in U.S. Pat. No. 5,211,875 to Speer et al. Each of the referenced patents is incorporated herein by reference in its entirety.

The term “oxygen-sensitive” as used herein refers to the ability of a product to react with oxygen. The term includes products that oxidize in the presence of oxygen, such as whole grains, fruit, and the like. The term also includes products such as fresh red meat that bloom in the presence of oxygen.

The term “oxygen transmission rate” or “OTR” or “oxygen permeability” is measured according to ASTM D3985, a test known to those of ordinary skill in the art, and which is hereby incorporated by reference in its entirety.

The term “package” as used herein refers to any means for holding a product (such as raw meat) including but not limited to a container, carton, casing parcel, holder, tray, flat, bag, film, envelope, and the like. In some embodiments, the term “package” can refer to the combination of all of the various components used in the packaging of a product, i.e., all components of the packaged product other than the product within the package. The package is inclusive of, for example, a support member and all films used to surround the product and/or support member. In some embodiments, the package can also be inclusive of an absorbent component such as a soaker pad and the atmosphere within the package, together with any additional components used in the packaging of the product.

As used herein, the term “perforation” refers to the formation of one or more cuts of a predetermined size and configurations through at least part of the thickness of a support means and/or film. The cuts can be made by any suitable means for achieving the desired length, depth, and/or configuration. In some embodiments, the cuts can be made using a laser-cutting means. For example, the support means and/or film can be at least partially penetrated by light pulses from a 100-800 watt carbon dioxide laser. Other suitable methods for creating cuts in package 5 would be readily apparent to one of ordinary skill in the art.

As used herein, the term “polymer” (and specific recited polymers) refer to the product of a polymerization reaction, and is inclusive of homopolymers, copolymers, terpolymers, etc.

As used herein, the term “polymerization” can be inclusive of homopolymerizations, copolymerizations, terpolymerizations, etc., and can include all types of copolymerizations such as random, graft, block, etc. In general, the polymers in the films of the presently disclosed subject matter can be prepared in accordance with any suitable polymerization process, including slurry polymerization, gas phase polymerization, high pressure polymerization processes, and the like.

As used herein, the term “preservation enhancing gas” refers to gases used in MAP applications as described herein. Particularly, such gas environments have a composition that is altered from that of ambient air for the purpose of extending the shelf life, enhancing the appearance, and/or reducing the degradation of a packaged product. Such gases can include (but are not limited to) carbon dioxide, carbon monoxide, nitrogen, argon, and mixtures of such gases, as would be apparent to those of ordinary skill in the packaging art.

As used herein, the term “seal” refers to any seal of a first region of a film surface to a second region of a film surface, wherein the seal is formed by heating the regions to at least their respective seal initiation temperatures. The heating can be performed by any one or more of a wide variety of manners, such as using a heated bar, hot air, infrared radiation, radio frequency radiation, etc.

As used herein, the phrases “seal layer”, “sealing layer”, “heat seal layer”, and “sealant layer”, refer to an outer film layer, or layers, involved in the sealing of the film to itself, another film layer of the same or another film, and/or another article that is not a film. It should also be recognized that in general, up to the outer 3 mils of a film can be involved in the sealing of the film to itself or another layer. With respect to packages having only fin-type seals, as opposed to lap-type seals, the phrase “sealant layer” generally refers to the inside film layer of an article, as well as supporting layers adjacent this sealant layer often being sealed to itself, and frequently serving as a food contact layer in the packaging of foods. In general, a sealant layer sealed by heat-sealing layer comprises any thermoplastic polymer. In some embodiments, the heat-sealing layer can comprise, for example, thermoplastic polyolefin, thermoplastic polyamide, thermoplastic polyester, and thermoplastic polyvinyl chloride. In some embodiments, the heat-sealing layer can comprise thermoplastic polyolefin.

As used herein, the phrase “support member” refers to a component of a package on or in which a product is disposed. In some embodiments, a support member can include a cavity into which the product is disposed and a peripheral flange that provides a sealing surface for attachment of a lid (i.e., a film) to the support member to thereby enclose the product within the cavity.

As used herein, the term “tie layer” refers to an internal film layer having the primary purpose of adhering two layers to one another. In some embodiments, tie layers can comprise any nonpolar polymer having a polar group grafted thereon, such that the polymer is capable of covalent bonding to polar polymers such as polyamide and ethylene/vinyl alcohol copolymer. In some embodiments, tie layers can comprise at least one member selected from the group including, but not limited to, modified polyolefin, modified ethylene/vinyl acetate copolymer, and/or homogeneous ethylene/alpha-olefin copolymer. In some embodiments, tie layers can comprise at least one member selected from the group consisting of anhydride modified grafted linear low density polyethylene, anhydride grafted low density polyethylene, homogeneous ethylene/alpha-olefin copolymer, and/or anhydride grafted ethylene/vinyl acetate copolymer.

Although the majority of the above definitions are substantially as understood by those of skill in the art, one or more of the above definitions can be defined hereinabove in a manner differing from the meaning as ordinarily understood by those of skill in the art, due to the particular description herein of the presently disclosed subject matter.

### III. The Disclosed Package

III.A. Support Member 10

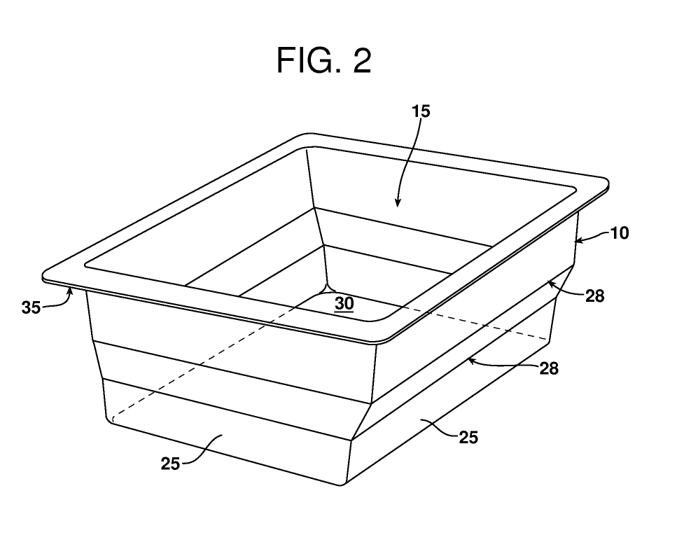

As set forth herein above, package 5 comprises collapsible support member 10. As illustrated in FIG. 2, in some embodiments, support member 10 is in the form of a tray having side walls 25 and base 30 that define a cavity into which product 20 can be disposed. In some embodiments, flange 35 extends from side walls 25 to provide a sealing surface for attachment of film 40 to the support member to enclose product 20 within cavity 15.

Support member 10 can have any desired configuration or shape, e.g., rectangular, round, oval, and the like. Similarly, flange 35 can have any desired shape or design, including a simple, substantially flat design that presents a single sealing surface as shown in the Figures, or a more elaborate design that presents two or more sealing surfaces, as disclosed in U.S. Pat. No. 5,348,752 to Gorlich and U.S. Pat. No. 5,438,132 to Bray et al., the disclosures of which are incorporated by reference herein in their entireties. In some embodiments, flange 35 can also include a peripheral lip positioned adjacent and exterior to the sealing surface to facilitate the peelable delamination of film 40.

The support member can be substantially rigid, semi-rigid, or flexible. For example, the support member can have a 1% secant flex modulus of at least about any of the following values: 120,000; 140,000; 160,000; 180,000; 200,000; 225,000; or 250,000 pounds/square inch (in accordance with ASTM D-790).

Suitable materials from which support member 10 can be formed include (but are not limited to) polyvinylchloride, low density polyethylene, high density polyethylene, polystyrene, polypropylene, polyethylene terephthalate (PET), crystalline polyethylene terephthalate (CPET), amorphous polyethylene terephthalate (APET), polyamides (nylons), polylactic acid (PLA), polyhydroxyalkanoates (PHAs), polycarbonate (PC), polymethyl methacrylate (PMMA), polysiloxanes (silicones), paper pulp, polyurethane, and cellulose.

In some embodiments, support member 10 can have a substantially gas-impermeable sealant film laminated or otherwise bonded to the inner (upper) surface thereof as disclosed in U.S. Pat. Nos. 4,847,148 and 4,935,089, and in U.S. Ser. No. 08/326,176, filed Oct. 19, 1994 and entitled “Film/Substrate Composite Material” (published as EP 0 707 955 A1 on Apr. 24, 1996), the disclosures of which are hereby incorporated by reference. Alternatively or in addition, in some embodiments, support member 10 can comprise any combination of plastic, paper, glass, aluminum or other metal coatings, and/or coextrusions or laminations of such materials laminated or otherwise bonded to the inner (upper) surface thereof. In some embodiments, the materials used to form support member 10 can comprise one or more barrier layers, sealant layers, abuse layers, tie layers, and/or bulk layers. Such layers are well known to those of ordinary skill in the art.

In the case of red meat or similar products that can include liquids of any type, the material used to construct support member 10 can be comparably dense to prevent seepage of the liquid. Absorbent trays such as those supplied by Vitembal (Avignon, France) or Linpak (Swanton, Ohio, United States of America) can be employed for this purpose. In addition, in some embodiments, support member 10 can comprise a soaker pad to absorb product drip loss and to further prevent or reduce discoloration of product 20. Examples of such absorbent pads are provided in U.S. Pat. No. 5,320,895 to Larsonneur et al. and U.S. Pat. No. 6,278,371 to Hopkins, the entire disclosures of which are incorporated herein by reference.

In some embodiments, support member 10 can have a thickness ranging from about 10 mils to about 25 mils (250 to 625 microns). The thickness of side walls 25 can be equal to or less than the thickness of base 30.

In some embodiments, support member 10 can have oxygen transmission barrier attributes, particularly when product 20 is an oxygen-sensitive food product. In these embodiments, support member 10 can have a thickness and composition sufficient to provide an oxygen transmission rate of no more than about any of the following values: 1000, 500, 150, 100, 50, 45, 40, 35, 30, 25, 20, 15, 10, 5, or 1 cubic centimeters (at standard temperature and pressure) per square meter per day per 1 atmosphere of oxygen pressure differential measured at 0% relative humidity and 23° C. (ASTM D-3985).

In some embodiments, support member 10 can comprise an easy open feature. One of ordinary skill in the art would recognize that any of a number of suitable opening means can be included within the presently disclosed subject matter. For example, ring pull tabs, zippers, and the like can be used. See, for example, U.S. Pat. No. 7,419,301 to Schneider et al.; U.S. Pat. No. 7,395,642 to Plourde et al.; U.S. Pat. No. 7,322,920 to Johnson; U.S. Pat. No. 7,261,468 to Schneider et al.; U.S. Pat. No. 6,539,691 to Beer; U.S. Pat. No. 5,121,997 to La Pierre et al.; U.S. Pat. No. 5,100,246 to La Pierre et al.; U.S. Pat. No. 5,077,064 to Hustad et al.; U.S. Pat. No. 5,022,530 to Zieke; U.S. Pat. No. 6,976,588 to Wischusen et al.; U.S. Pat. No. 5,865,335 to Farrell et al.; U.S. Pat. No. 5,332,150 to Poirier; U.S. Pat. No. 4,778,059 to Martin et al.; and U.S. Pat. No. 4,680,340 to Oreglia et al., the entire disclosures of which are incorporated herein by reference.

Although the support members (and other packaging articles) depicted in the enclosed Figures depict only one compartment to house product 20, it is within the scope of the presently disclosed subject matter that the disclosed package can include containers formed with one or more compartments to house a plurality of products.

Support member 10 comprises a collapsing mechanism. In some embodiments, the collapsing mechanism can be positioned about the circumference of side walls 25 to enable the support member to collapse. In some embodiments, the collapsing mechanism is generally orthogonal to the direction of collapse and can be about parallel to the plane of base 30. Transformation of support member 10 into a collapsed condition is in response to compressive applied forces in the collapse direction, as set forth in more detail herein below.

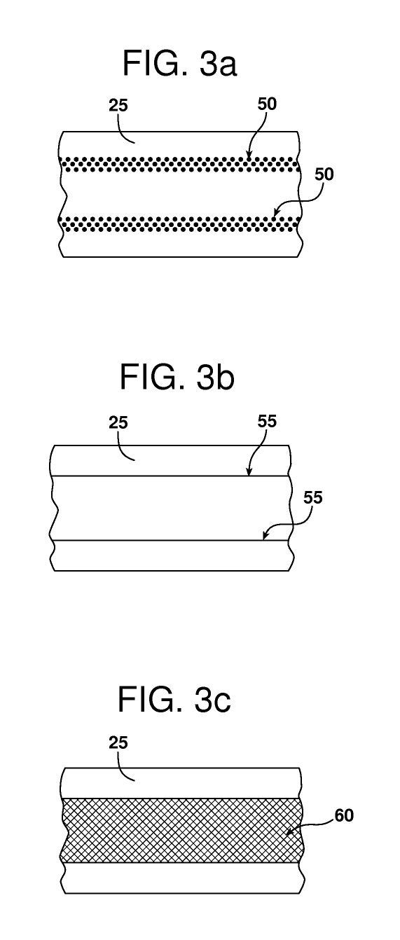

In some embodiments, the collapsing mechanism can comprise hinge lines 28 that allow sidewalls 25 to collapse upon themselves. For example, as depicted in FIGS. 3a-3c, the hinge line can comprise perforations 50, score lines 55, and/or offset material 60. In the embodiments depicted in FIGS. 3a-3c, each hinge line can be continuous at sidewalls 25 and can be disposed about the same distance from base 30. The hinge lines shown in FIGS. 3a-3c function as a line of weakness, thereby allowing the sidewalls to collapse or fold upon themselves, as discussed in more detail herein below.

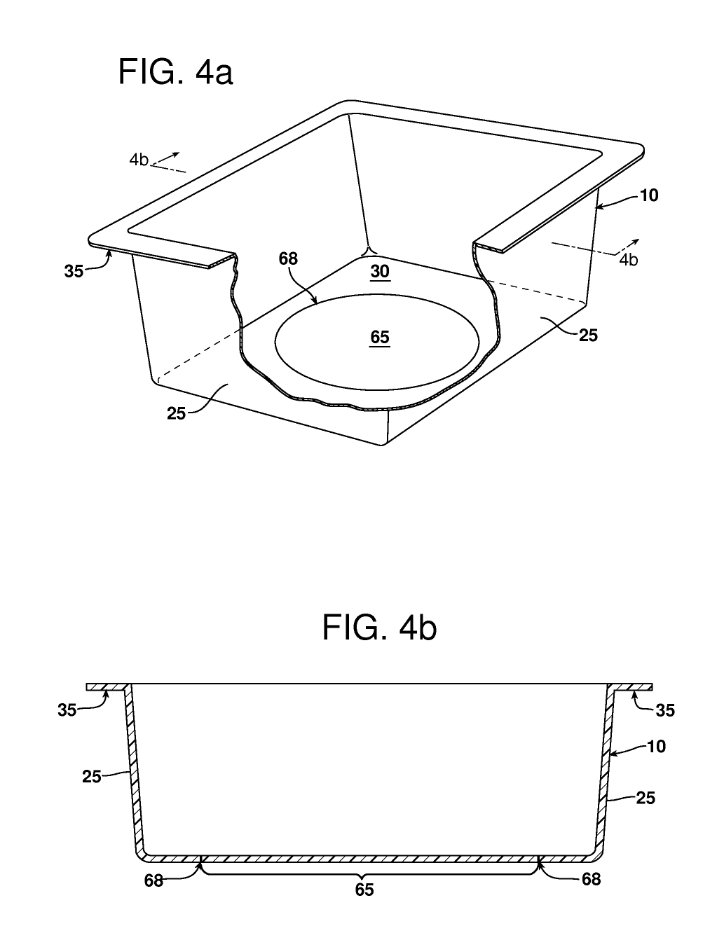

Alternatively or in addition, in some embodiments, the collapsing mechanism can be positioned on base 30 of the support member, as illustrated in FIGS. 4a and 4b. Particularly, base 30 can comprise projecting wall area 65 that can be displaced toward the interior of the package when pressed by a finger or other item inward. As a result, product 20 is elevated to contact film 40, as set forth in more detail herein below. Projecting wall area 65 can be formed integrally with base 30 via bending line 68. Although depicted as circular in shape in the Figures, one of ordinary skill in the art would recognize that the central pressure area can be formed in any of a wide variety of shapes, including (but not limited to) oval, square, rectangular, triangular, and the like.

III.B. Film 40

As depicted in FIGS. 1a and 1b, film 40 can be hermetically sealed to support member 10 along flange 35 such that package 5 is substantially air and liquid tight (i.e., sealed). Thus, film 40 can be sealed to support member 10 such that package 5 surrounds product 20 on all sides to reliably contain the product in its respective cavity before, during, and after collapse of the support member has been initiated.

In some embodiments, film 40 can be any suitable barrier film that is substantially impermeable to gas (such as oxygen). Thus, in some embodiments, film 40 can comprise one or more of the following: ethylene/vinyl alcohol copolymer, polyvinylidene chloride, polyalkylene carbonate, polyamide, polyethylene naphthalate, polyester, polyacrylonitrile, metallized polymer films, and combinations thereof, as known to those of skill in the art.

In some embodiments, barrier films suitable for use with the presently disclosed subject matter can have oxygen permeability of less than 500 cm³ O₂/m²·day·atm; in some embodiments, less than 100 cm³ O₂/m²·day·atm; in some embodiments, less than 50 cm³ O₂/m²·day·atm; in some embodiments, less than 25 cm³ O₂/m²·day·atm; in some embodiments, less than 10 cm³ O₂/m²·day·atm; in some embodiments, less than 5 cm³ O₂/m²·day·atm; and in some embodiments, less than 1 cm³ O₂/m²·day·atm (tested at 1 mil thick and at 25° C. in accordance with ASTM D3985).

Alternatively, film 40 can be oxygen permeable in embodiments wherein package 5 is enclosed within a barrier overwrap, as discussed in more detail below. Thus, in such embodiments, film 40 can comprise oxygen permeable materials, such as (but not limited to) ethylene/vinyl acetate (EVA) and/or ethylene/acrylic acid (EAA). As used herein, the term “oxygen permeable film” refers to a film packaging material that can permit the transfer of oxygen from the exterior of the package to the interior of the package. In some embodiments, oxygen permeable films can have a permeability of greater than about 10,000 cc/m²·day·atm at 73° C. and in some embodiments, greater than about 17,000 cc/m²·day·atm at 73° C.

Thus, film 40 can be provided in sheet or film form and can be any of the films commonly used for the disclosed type of packaging. Accordingly, film 40 can comprise one or more barrier layers, seal layers, tie layers, abuse layers, and/or bulk layers. The polymer components used to fabricate film 40 according to the presently disclosed subject matter can also comprise appropriate amounts of other additives normally included in such compositions. For example, slip agents (such as talc), antioxidants, fillers, dyes, pigments and dyes, radiation stabilizers, antistatic agents, elastomers, and the like can be added to the disclosed films. See, for example, U.S. Pat. No. 7,205,040 to Peiffer et al.; U.S. Pat. No. 7,160,378 to Eadie et al.; U.S. Pat. No. 7,160,604 to Ginossatis; U.S. Pat. No. 6,472,081 to Tsai et al.; U.S. Pat. No. 6,222,261 to Horn et al.; U.S. Pat. No. 6,221,470 to Clacca et al.; U.S. Pat. No. 5,591,520 to Migliorini et al.; and U.S. Pat. No. 5,061,534 to Blemberg et al., the disclosures of which are hereby incorporated by reference in their entireties.

Generally, the films employed in the presently disclosed package can be multilayer or monolayer. Typically, however, the films employed will have two or more layers to incorporate a variety of properties, such as, for example, sealability, gas impermeability, and toughness into a single film. Thus, in some embodiments, film 40 comprises a total of from about 4 to about 20 layers; in some embodiments, from about 4 to about 12 layers; and in some embodiments, from about 5 to about 9 layers. Accordingly, the disclosed film can comprise 1, 2, 3, 4, 5, 6, 7, 8, 9, 10, 11, 12, 13, 14, 15, 16, 17, 18, 19, or 20 layers.

Film 40 can have any total thickness desired, so long as the film provides the desired properties for the particular packaging operation in which the film is used, e.g., optics, modulus, seal strength, and the like. Final web thicknesses can vary, depending on process, end use application, and the like. Typical thicknesses can range from about 0.1 to 20 mils; in some embodiments, about 0.3 to 15 mils; in some embodiments, about 0.5 to 10 mils; in some embodiments, about 1 to 8 mils; in some embodiments, about 1 to 4 mils; and in some embodiments, about 1 to 2 mils.

In some embodiments, film 40 can be transparent (at least in the non-printed regions) such that product 20 is visible through the film. The term “transparent” as used herein can refer to the ability of a material to transmit incident light with negligible scattering and little absorption, enabling objects (e.g., packaged food or print) to be seen clearly through the material under typical unaided viewing conditions (i.e., the expected use conditions of the material). The transparency of the film can be at least about any of the following values: 20%, 25%, 30%, 40%, 50%, 65%, 70%, 75%, 80%, 85%, and 95%, as measured in accordance with ASTM D1746.

III.C. Product 20

Products that can be housed using the disclosed package and methods can include (but are not limited to) food products. Examples of food products that are suitable for use with the presently disclosed subject matter include, but are not limited to, meat such as beef, veal, lamb, pork, birds such as poultry (including chicken, duck, goose, turkey, and the like), buffalo, camel, dog, game (including deer, eland, antelope, and the like), game birds (such as pigeon, quail, doves, and the like), goat, hare, horse, kangaroo, lamb, marine mammals (including whales and the like), pig, rabbit, and/or sheep. One of ordinary skill in the art would readily recognize that the above list is not exhaustive and can include any of a variety of meat products.

Further, non-food items suitable for use with the presently disclosed subject matter can include (but are not limited to) pharmaceuticals, photographic film, computer components, inorganic materials susceptible to oxidation, electronics, biological systems, and the like. For example, a non-food item can be packaged using the presently disclosed subject matter wherein non-contact with film 40 provides better storage stability and later film contact provides better appearance at the time of sale. One of ordinary skill in the art would readily recognize that the above list is not exhaustive and can include any of a variety of non-food items.

### IV. Methods of Making the Disclosed Package

IV.A. Support Member 10

In some embodiments, support member 10 can be fabricated from a sheet or web that is thermoformed to produce an article of desired shape. Thermoforming is well known in the packaging art, and is the process whereby a thermoplastic web is heat softened and reshaped to conform to the shape of a cavity in a mold. Suitable thermoforming methods, for example, include a vacuum forming or plug-assist vacuum forming method. In a vacuum forming method, the first web is heated, for example, by a contact heater, and a vacuum is applied beneath the web causing the web to be pushed by atmospheric pressure down into a pre-formed mold. In a plug-assist vacuum forming method, after the first or forming web has been heated and sealed across a mold cavity, a plug shape similar to the mold shape impinges on the forming web and, upon the application of vacuum, the forming web transfers to the mold surface.

In embodiments wherein support member 10 comprises perforations 50 (or vents or punctures), one of ordinary skill in the art would appreciate that such items can be made in any of a wide variety of ways. For example, in some embodiments, the perforations can be constructed using any suitable mechanism, including the use of mechanical, chemical or electrical devices. Nonlimiting examples of such devices include those that perforate with a laser, electrostatic discharge, ultrasonic waves, flame discharge, a needle, or combinations thereof. See, for example, U.S. Pat. No. 5,257,923 to Kagawa and U.S. Pat. No. 5,352,108 to Kagawa et al., the disclosures of which are hereby incorporated by reference.

In embodiments wherein support member 10 comprises score lines 55, one of ordinary skill in the art would appreciate that such score lines can be made in any of a wide variety of ways. For example, in some embodiments, the score lines can be laser cut or cut using a blunt scoring knife to extend partially through sidewall 25 of the support member.

In embodiments wherein support member 10 comprises offset material 60, one of ordinary skill in the art would appreciate that such a support member can be constructed in any of a wide variety of ways. For example, the support member can be constructed from materials that are molded with thick and thin wall sections to provide flexibility. Alternatively, support member 10 can be injection molded from two varying materials, with offset material 60 constructed from a lower modulus material to provide flexibility.

One of ordinary skill in the art would appreciate that embodiments wherein support member 10 comprises a central pressure area (such as projecting wall area 65) can be constructed in any of a wide variety of ways. For example, central pressure area 65 can be constructed by a suitable shape that is molded into support member 10, as would be well known to those of ordinary skill in the packaging art.

IV.B. Film 40

Film 40 can be a monolayer structure or a multilayered structure having various layers that are produced by any suitable process known to those of ordinary skill in the art, including (but not limited to) coextrusion, lamination, extrusion coating, and combinations thereof. See, for example, U.S. Pat. No. 6,769,227 to Mumpower, the content of which is incorporated by reference herein in its entirety. Thus, in some embodiments, film 40 can be coextruded or laminated and can be adhered together with a coextruded tie layer. The typical film-to-film bond from lamination can be made by adhering the films together with a thin layer of polyurethane coating on an adhesive laminator. The lamination can also be accomplished by extrusion lamination or extrusion coating with an adhesive coextrusion tie layer type resin at the bond interface.

In some embodiments, at least a portion of film 40 can be irradiated to induce crosslinking. In the irradiation process, the film is subjected to one or more energetic radiation treatments, such as corona discharge, plasma, flame, ultraviolet, X-ray, gamma ray, beta ray, and high energy electron treatment, each of which induces cross-linking between molecules of the irradiated material. The irradiation of polymeric films is disclosed in U.S. Pat. No. 4,064,296, to Bornstein et al., which is hereby incorporated by reference in its entirety.

IV.C. Package 5

To construct package 5, the item to be packaged (e.g., product 20) can be placed onto base 30 of support member 10. Film 40 can then be placed over the support member so that the film contacts flange 35. Film 40 can be supplied from a larger web, such as from a roll that is unwound to supply web as needed.

In some embodiments, a heated bar or member engages the perimeter of film 40 corresponding with flange 35 to compress the film against the flange of the support member. The resulting heat transfer and compression enables the sealant layer of the film and surface layer of the support member to soften and intermix with one another, as is well known in the packaging art. The heat from the sealing operation can also initiate shrinking of the film to reduce the amount of wrinkles or waves that can otherwise form in the film. A representative process for heat sealing a film to a support member is described in U.S. Pat. No. 5,779,050 to Kocher, which is incorporated herein by reference. The resulting heat-weld or heat-seal extends continuously around the upper surface of flange 35 to hermetically seal or enclose product 20 within package 5. In this manner, film 40 and support member 10 can form a substantially gas-impermeable enclosure for product 20 to protect it from contact with the surrounding environment, including atmospheric oxygen, dirt, dust, moisture, liquid, and/or microbial contaminates.

Alternatively or in addition, the sealing of film 40 to support member 10 can be achieved by impulse sealing, ultrasonic sealing, dielectric sealing, and/or the use of an adhesive, as would be well known to those of ordinary skill in the packaging art.

The excess film material extending beyond the flange can be trimmed by a standard cutting operation. Further, if the film is supplied from a roll, portions can be severed from the web after or simultaneously with the heat-welding of the film to support member 10. Film 40 can be severed by a conventional cutting device (e.g., a sharp cutting instrument or a thermal cutting device such as a heated wire or heated blade).

The resulting bond between film 40 and support member 10 is sufficiently strong to withstand the expected use conditions. For example, in some embodiments, the heat seal bond strength can be at least about any of the following values: 0.5, 0.6, 0.7, 0.8, 0.9. 1, 1.3, 1.5, 1.8, 2, 2.5, 3, 3.5, 4, 4.5, 5, 5.5, 6, 6.5, 7, 7.5, and 8 pound/inch. The term “heat seal bond strength” as used herein refers to the amount of force required to separate the sealant layer of the film from the support member to which the sealant layer has been sealed, as measured in accordance with ASTM F88-94 where the Instron tensile tester crosshead speed is 5 inches per second, using five, 1-inch wide, representative samples.

In some embodiments, package 5 can be a modified atmosphere package (“MAP”), wherein product 20 is maintained in a sealed container with a headspace of an atmosphere that is different than ambient air. Particularly, in MAP packaging, prior to securing film 40 to the flange of the support member, ambient air is evacuated from the interior of the support member and replaced with a gas that differs from ambient air. For example, fresh meat and other food products can be packaged in a low-oxygen environment (e.g, high levels of carbon dioxide and/or nitrogen) after evacuating all or most of the air from the package. Alternatively, product 20 can be exposed to carbon dioxide, then packaged in a low oxygen MAP, as would be well known to those of ordinary skill in the packaging art. MAP systems are well known to those of ordinary skill in the art. Examples of such MAP packaging are disclosed in U.S. Pat. No. 5,686,126 to Noel et al. and U.S. Pat. No. 5,779,050 to Kocher et al., the entire disclosures of which are hereby incorporated by reference.

In MAP packaging, any desired amount of air can be removed from cavity 15 of support member 10 during the evacuation step, e.g., ranging from 1% to 99.999% by volume. In embodiments wherein a fresh red meat product is to be packaged, the amount of air removed can range from about 99% to about 99.999%, and in some embodiments from about 99.5% to about 99.999% by volume. Thus, in some embodiments, the oxygen level within package 5 can be reduced to a first level in the range of less than 0.5% and in some embodiments less than 0.05%. The reduction in oxygen level can be accomplished using one or more techniques, including but not limited to, evacuation, gas flushing, and/or oxygen scavenging. Such methods are well known to those of ordinary skill in the packaging art. For example, during a gas flushing process, an appropriate mixture of gases is introduced into the cavity of package 5 to create a modified atmosphere therein.

Examples of low oxygen environments include, but are not limited to, about 30 volume percent carbon dioxide and about 70 volume percent nitrogen, with up to about 5 volume percent carbon monoxide. It is contemplated that other combinations of carbon dioxide and nitrogen can be used. For example, the low oxygen environment can include from about 40 to about 80 volume percent nitrogen and from about 15 to about 60 volume percent carbon dioxide. The low oxygen environment can include from about 0.1 volume percent to about 3.0 volume percent carbon monoxide. In one alternative embodiment, the modified atmosphere can comprise about 0.4 volume percent carbon monoxide, about 30 volume percent carbon dioxide, with nitrogen comprising the remaining balance. In some embodiments, the modified atmosphere can include additional gases in the mixture, for example, one or more noble gases.

In embodiments wherein product 20 comprises a red meat product, the cut of meat within the modified atmosphere package takes on a purple-red color when the oxygen is removed from the interior of package 5. The modified package can then be stored in a refrigeration unit for several weeks prior to being offered for sale at a retail establishment. It should be noted that the presently disclosed subject matter also comprises embodiments wherein package 10 is not a modified atmosphere package and the package interior comprises ambient air.

In some embodiments, package 5 can include a label that can include product information, such as pricing, description, expiration date, and the like. The label can be adhesively or otherwise affixed to package 5 on film 40 and/or support member 10, as would be apparent to those of skill in the art. The label can be placed on the package at the point of packaging or by the retailer at the point of sale.

### V. Methods of Using the Disclosed Package

The presently disclosed subject matter is directed to a package comprising a support member that can be collapsed on demand, as depicted in the Figures. For example, in some embodiments, it can be desirable to store the package in an uncollapsed condition until the time of display at a retail establishment for purchase by a consumer. Thus, package 5 can be produced at a central processing facility for subsequent distribution to retail outlets (such as butcher shops, grocery stores, and the like). To this end, in some embodiments, package 5 can contain a case-ready meat product comprising fresh meat. Case-ready meat products can be generally defined as fresh meat that is pre-packaged and optionally pre-labeled at a centralized location and delivered to the retail market prepared for final sale.

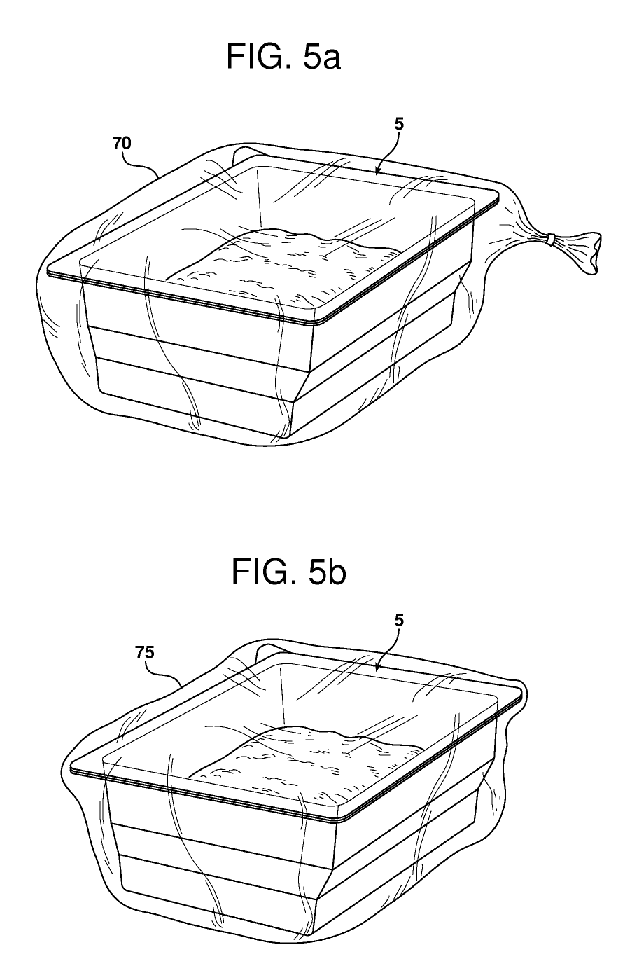

Particularly, package 5 is initially configured as set forth in FIG. 1a or 4a (i.e., in an uncollapsed condition). In embodiments wherein film 40 and/or support member 10 are oxygen permeable, package 5 can require a barrier application to prevent premature bloom of the packaged product. In some embodiments, the barrier application can be a bag structure (i.e., mother bag) such that the entire package is completely enclosed and sealed within bag 70, as depicted in FIG. 5a. Bag 70 can be constructed from a barrier material that is essentially impervious to oxygen. For example, in some embodiments, bag 70 can comprise one or more of the following: ethylene/vinyl alcohol copolymer, polyvinyl alcohol homopolymer, polyvinyl chloride, homopolymer and copolymer of polyvinylidene chloride, polyalkylene carbonate, polyamide, polyethylene naphthalate, polyester, polyacrylonitrile, homopolymer and copolymer, liquid crystal polymer, SiOx, carbon, metal, metal oxide, and the like. After insertion of package 5 into bag 70, the bag can then be sealed to prevent the influx of oxygen from the ambient atmosphere into package 5.

In some embodiments, bag 70 can be evacuated of normal atmosphere and flushed with a preservation-enhancing gas, such as, for example, a mixture of gases comprising about 30% carbon dioxide and about 70% nitrogen prior to sealing the bag. Alternatively or in addition, in some embodiments, bag 70 can be evacuated of normal atmosphere and then flushed with a gas mixture comprising carbon monoxide (in some embodiments, about 1 to 10% by volume CO; in some embodiments, from 0.1 to 5% CO; in some embodiments, about 4.5% or less of CO, wherein the remainder of the gas mixture can be a preservation-enhancing gas, such as CO₂ and/or N₂, as would be known to those of ordinary skill in the art) prior to sealing the bag. Such bags are known to those of ordinary skill in the packaging art. See, for example, U.S. Pat. No. 6,716,499 to Vadhar; U.S. Pat. No. 6,544,660 to Lind; U.S. Pat. No. 4,755,402 to Oberle; and U.S. Pat. No. 4,716,061 to Winter, the entire disclosures of which are incorporated herein by reference. At the time that it is desired to collapse package 5, the package can be removed from bag 70 to allow atmospheric oxygen to permeate the oxygen permeable film and/or support member 10.

As an alternative to bag 70, in some embodiments, the barrier application can comprise an oxygen-impermeable overwrap. Specifically, as depicted in FIG. 5b, overwrap 75 can be wrapped around the entire package to provide a barrier to the influx of oxygen into the package interior. Barrier overwrap 75 is capable of completely adhering or clinging to itself or to the package to complete the packaging closure. In some embodiments, barrier overwrap 75 can be pressed into a heated plate to weld together the folds of the film at a desired location. Such overwrapped films are well known in the packaging art. See, for example, U.S. Pat. No. 6,408,598 to Stockley; U.S. Pat. No. 5,663,002 to Schirmer; U.S. Pat. No. 4,759,444 to Barmore; U.S. Pat. No. 5,018,623 to Hrenyo; and U.S. Pat. No. 5,503,858 to Reskow, the entire disclosures of which are incorporated herein by reference. In some embodiments, barrier overwrap 75 can comprise one or more of the following materials: ethylene/vinyl alcohol copolymer, polyvinyl alcohol homopolymer, polyvinyl chloride, homopolymer and copolymer of polyvinylidene chloride, polyalkylene carbonate, polyamide, polyethylene naphthalate, polyester, polyacrylonitrile, homopolymer and copolymer, liquid crystal polymer, SiOx, carbon, metal, metal oxide, and the like. At the time that it is desired to collapse package 5, overwrap 75 can be removed from the package to allow atmospheric oxygen to permeate the oxygen permeable film and/or support member 10.

As would be apparent to those of ordinary skill in the art, in embodiments wherein film 40 and support means 10 are constructed from barrier materials, there is no requirement to provide bag 70 or overwrap 75. Rather, the package materials themselves provide a barrier to atmospheric conditions.

At the desired time, a user can collapse support member 10 at hinge lines 28 to allow film 40 to contact product 20, thereby creating a traditional overwapped package appearance. To this end, at the desired time, the user can apply pressure to flange 35 in the direction of the intended collapse using his fingers or another suitable object. The collapsing mechanism positioned in side walls 25 or base 30 then enables the support member to collapse on demand.

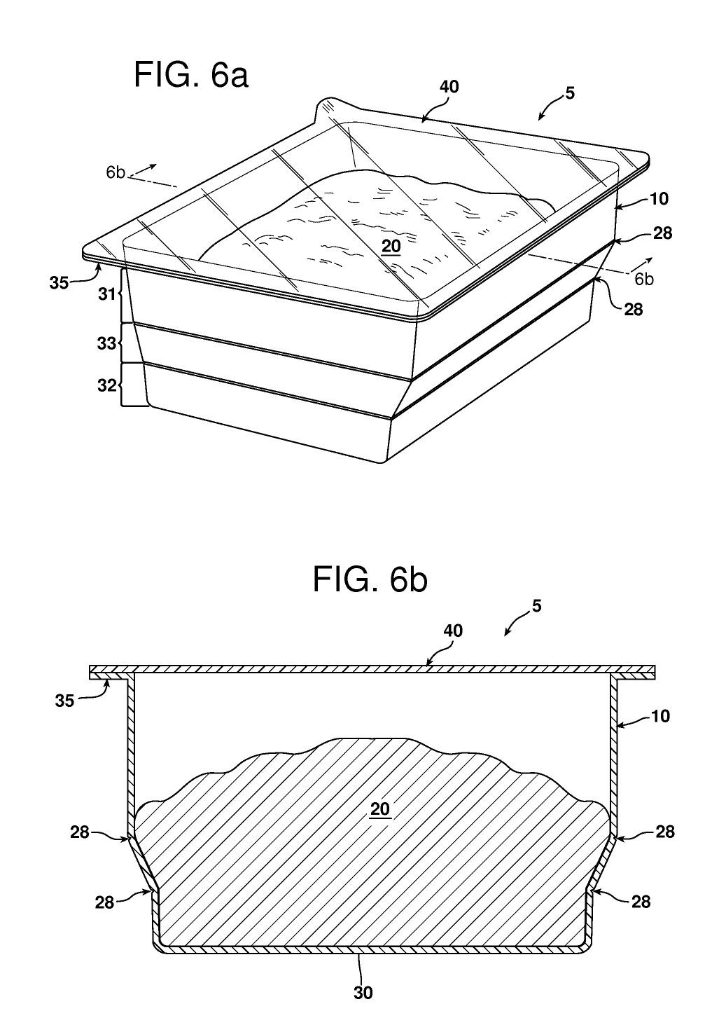

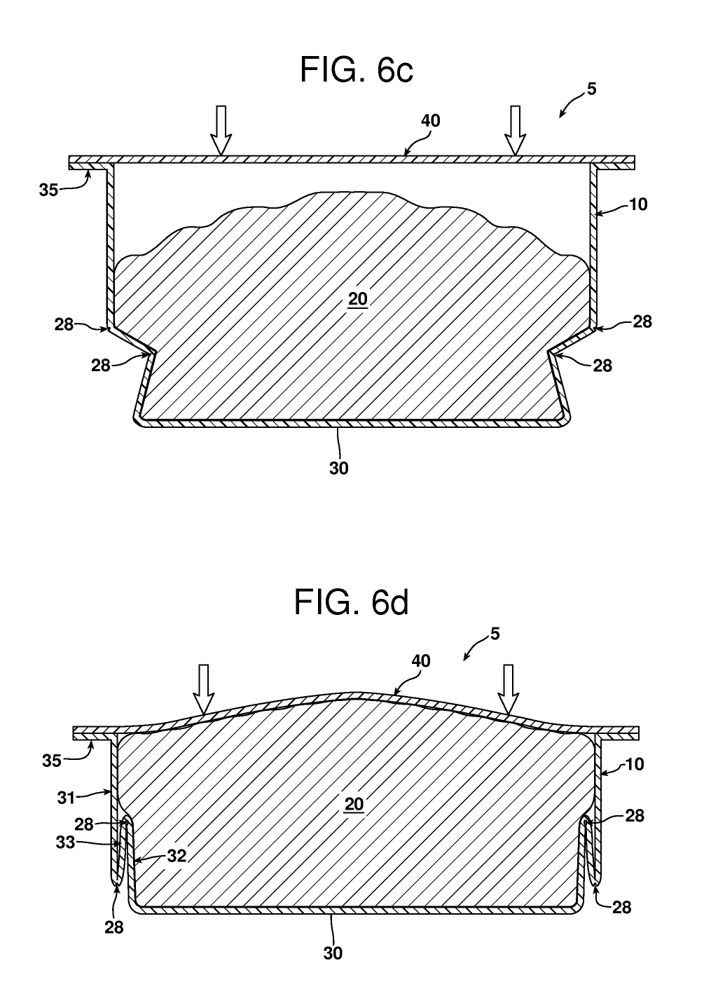

To elaborate, FIGS. 6a and 6b illustrate one embodiment wherein the collapsing mechanism comprises hinge lines 28 positioned in sidewall 25 of support member 10. Hinge lines 28 act as a line of weakness to enable the package to collapse. In addition, the hinge lines divide each sidewall into upper portion 31, lower portion 32, and folding portion 33, as depicted in FIG. 6a. Transformation of support member 10 into the collapsed condition is in response to compressively applied forces having a vector component parallel to the collapse direction. Upon initiating the folding action, folding portion 33 of sidewalls 25 distorts slightly until it flips into the folded position, as depicted in FIGS. 6c and 6d. Thus, hinge lines 28 act as a flexible hinge area that will flex in the direction of the fold. Because of the nature of the construction of package 5 as well as the angle of the fold in the collapsed position, package 5 will remain in collapsed position.

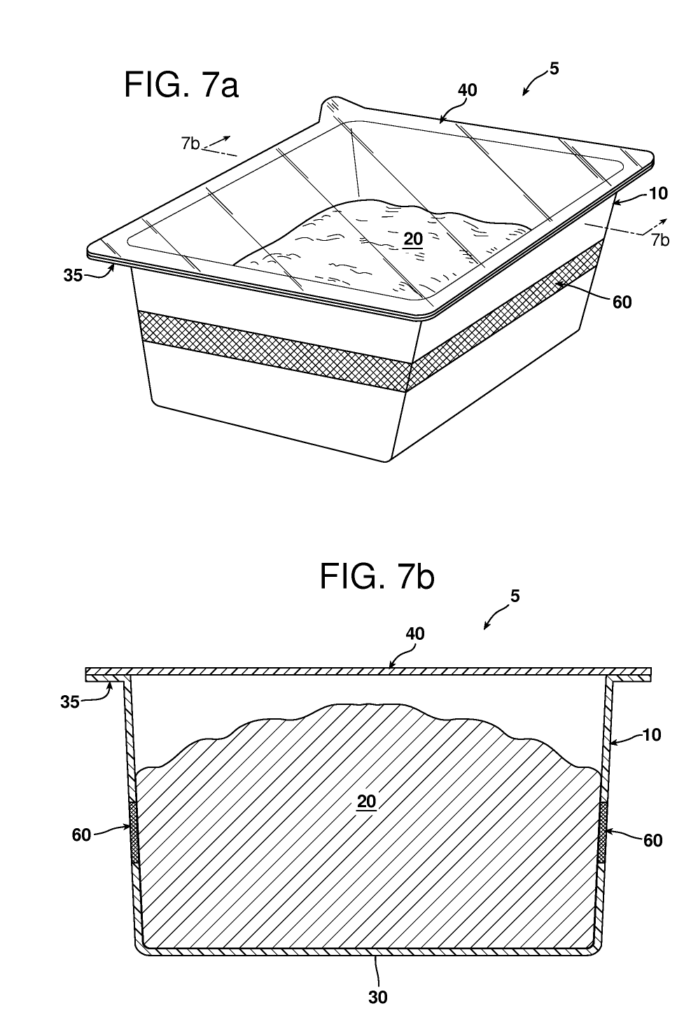

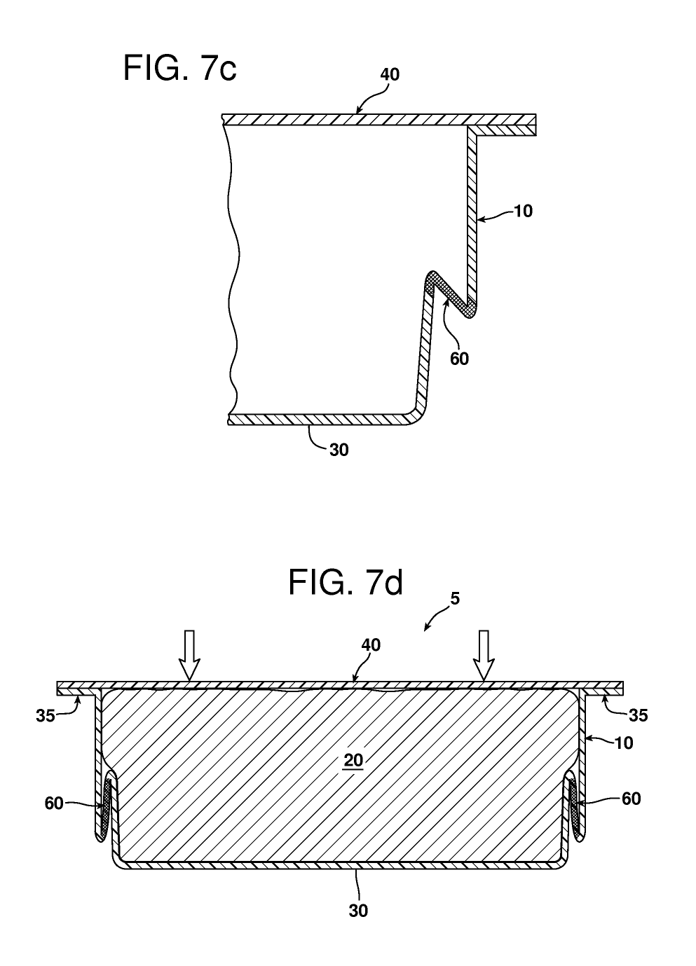

Continuing, FIGS. 7a and 7b illustrate one embodiment of uncollapsed package 5 wherein the collapsing mechanism comprises offset material 60. In some embodiments, the offset material can comprise a flexible material compared to side walls 25. Thus, the offset material can form a rolling bend as flange 35 is depressed, as illustrated in FIG. 7c. Specifically, the rolling bend is formed when manual pressure is applied to flange 35 in the direction of base 30. As a result, sidewalls 25 can bend with the applied pressure to form a collapsed package, as illustrated in FIG. 7d. Because of the nature of the materials used to form support member 10 and offset material 60, the package will remain collapsed.

After collapse of side wall 25, in some embodiments, there will be contact between film 40 and product 20, as illustrated in FIGS. 6d and 7d. Thus, the presently disclosed package allows for initial storage of a product (such as fresh red meat) without product-to-film contact, followed by compression and product-to-film contact. The resulting package after collapse has an appearance similar in likeness to conventional store overwrapped packages.

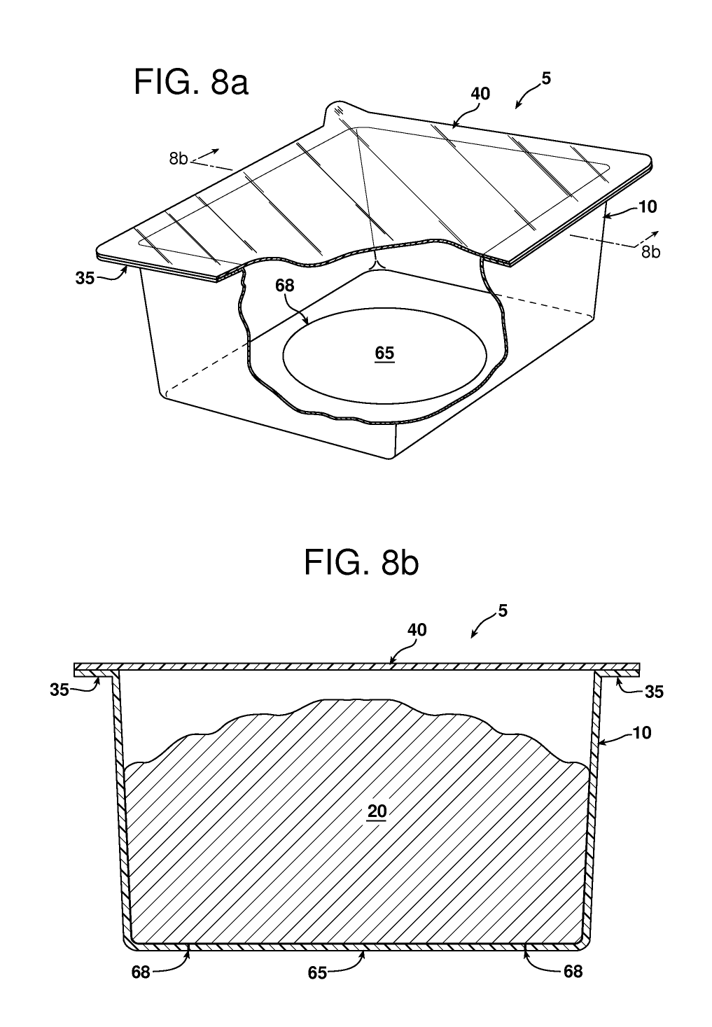

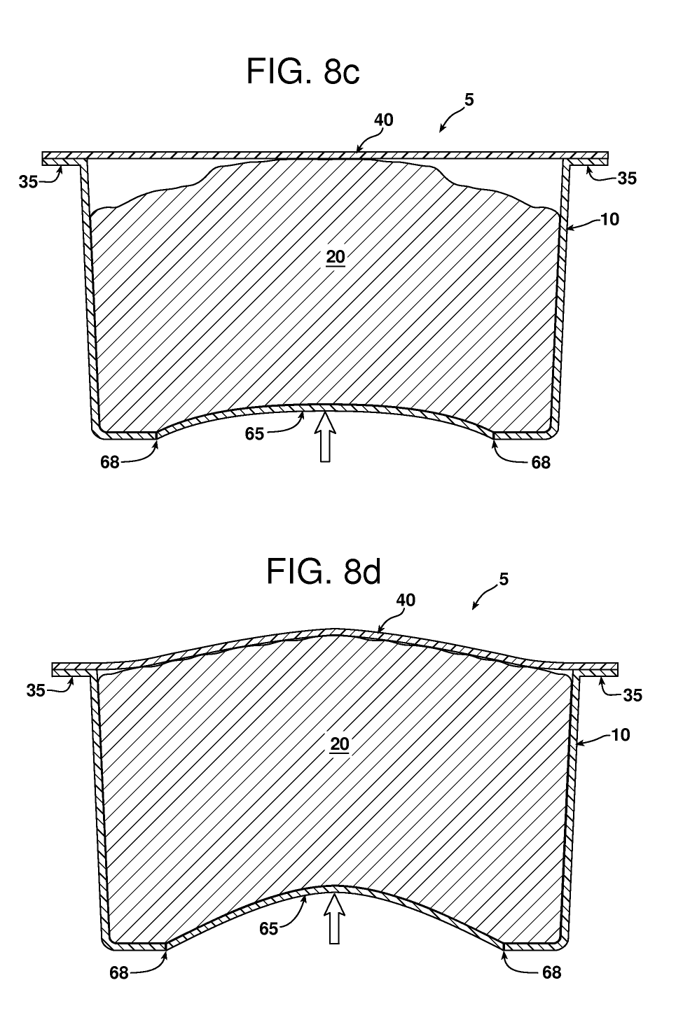

As illustrated in FIGS. 8a and 8b, in some embodiments the collapsing mechanism can comprise central pressure area, such as projecting wall area 65, positioned in base 30 of support member 10. At the time of desired collapse, a user simply applies an upward pressure to projecting wall area 65, as illustrated in FIG. 8c. After projecting wall area 65 has been uplifted fully, product 20 will be elevated and can contact film 40, as illustrated in FIG. 8d.

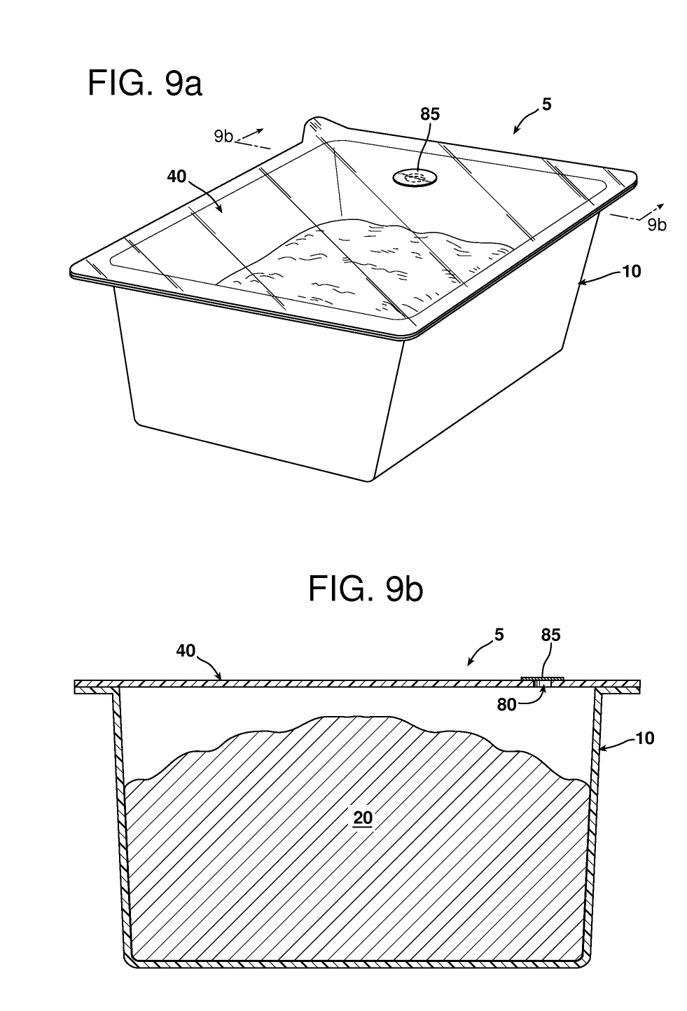

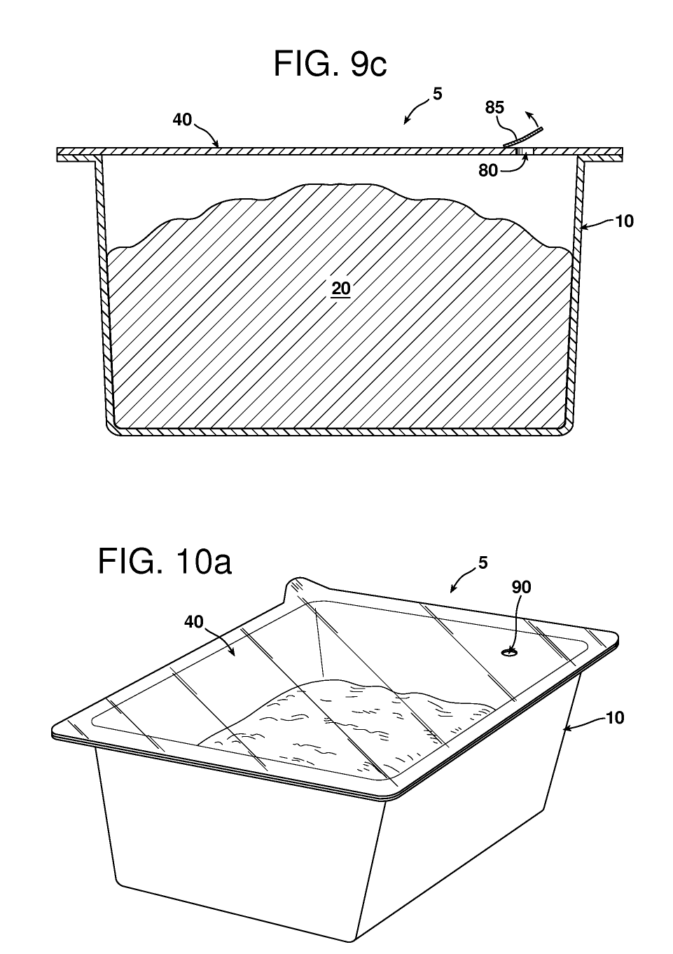

In some embodiments, in an effort to equalize internal gas pressure within cavity 15, it can be beneficial to vent package 5 prior to collapsing the support member. To this end, in some embodiments, package 5 can comprise vent 80 covered by label 85, as depicted in FIGS. 9a and 9b. In some embodiments, label 85 can be adhesively applied to package 5 to cover vent 80. Just prior to collapse of support member 10, label 85 can be removed to expose vent 80, as illustrated in FIG. 9c. One of ordinary skill in the art would appreciate that vent 80 can be constructed by any suitable means, including (but not limited to) laser cutting, hand-held tools, and the like. In addition, one of ordinary skill in the art would recognize that in lieu of a single vent as depicted in the Figures, a plurality of vents can be employed.

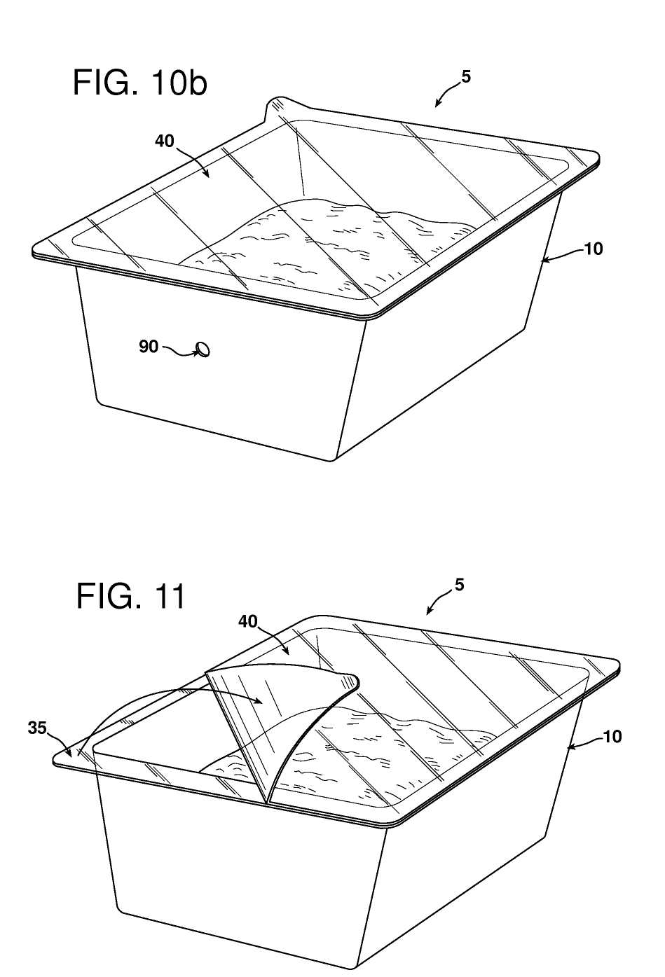

Alternatively or in addition, in some embodiments, support member 10 and/or film 40 can be punctured to equalize the internal gas pressure within the interior of the package, as depicted in FIGS. 10a and 10b. One of ordinary skill in the art would appreciate that punctures 90 can be constructed by any suitable means, including (but not limited to) laser cutting, hand-held tools, and the like.

The act of venting package 5 and/or removing the package from bag 70 and/or overwrap 75 allows atmospheric oxygen to enter the package. In embodiments wherein product 20 is fresh red meat, the atmospheric oxygen will allow product 20 to re-bloom. In this fashion, atmospheric air enters cavity 15 through film 40, support member 10, and/or vent 80 or punctures 90 to displace at least some of the gas that is lower in oxygen content than air. In this manner, atmospheric oxygen is permitted to come into contact with the packaged fresh red meat product and cause it to bloom to a bright red color that consumers associate with freshness.

When it is desired to access product 20 within package 5, film 40 can be removed simply and easily by a user. To this end, in some embodiments, package 5 comprises tab 45 or other easy opening means. In use, the user can easily use tab 45 to grasp film 40 and apply a force thereto by pulling generally upwards and backwards (i.e., towards an opposite edge or corner of the package). As a result, film 40 delaminates from support member 10, as illustrated in FIG. 11. Alternatively, the presently disclosed subject matter includes embodiments without such easy opening means. For example, a user can create a physical opening in the package, such as a knife cute, punched hole, etc.

### VI. Advantages of the Presently Disclosed Subject Matter

One benefit of the presently disclosed subject matter is that an oxygen sensitive product (such as fresh red meat) can be initially stored under barrier conditions with no product-to-film contact, followed by on demand product-to-film contact without any addition or removal of material from the package.

In addition, product-to-film contact can be delayed until any desired time (such as the time of retail display) for better preservation of product 20. For example, in embodiments wherein product 20 is fresh red meat, the delay of product-to-film contact can result in enhanced red meat color, reduced production of purge, and improved appearance of freshness. To this end, delaying contact can significantly enhance the appearance of some products (such as, for example, ground beef) by reducing compression over time, thereby providing a fresher appearance.

Continuing, the presently disclosed subject matter enables the amount of packaging materials and costs to be reduced compared to existing products that rely on barrier overwrap and/or mother bags.

Further, the presently disclosed package is also unique in appearance and has a display similar to traditional overwrapped packages.

In addition, the disclosed package has an improved aesthetic appearance of the package and product by collapse of the sidewalls or uplifting of the pressure area in the base of the package. As a result, film 40 contacts the packaged product, rendering it visually pleasing to the consumer.

Although several advantages of the disclosed system are set forth in detail herein, the list is by no means limiting. Particularly, one of ordinary skill in the art would recognize that there can be several advantages to the disclosed system that are not included herein.

What is claimed is:

1. A method of inducing bloom of a product on demand, said method comprising:
a. providing a package comprising:
i. a support member comprising side walls, a base for supporting a product, and a collapsing mechanism; and
ii. a lid;
b. placing a product on said base;
c. bonding said lid to said support member; and
d. initiating said collapsing mechanism to provide product-to-film contact on demand,
wherein said product-to-film contact enables the product to bloom.

2. The method of claim 1, wherein said collapsing mechanism comprises perforations, score lines, offset material, or combinations thereof in said side walls of said support member.

3. The package of claim 1, wherein said collapsing mechanism comprises a projecting wall area positioned in said base of said support member.

4. The method of claim 1, wherein said product is a fresh meat product.

5. The method of claim 1, wherein said package is a modified atmosphere package.

6. The method of claim 1, further comprising venting said package prior to initiating said collapsing mechanism.

7. A method of inducing product-to-film contact in a packaged product, said method comprising:
a. providing a package comprising:
i. a support member comprising side walls, a base for supporting a product, and a collapsing mechanism; and
ii. a lid;
b. placing a product on said base;
c. bonding said lid to said support member; and
d. initiating said collapsing mechanism to provide product-to-film contact on demand
wherein said product blooms in response to said product-to-film contact.

8. The method of claim 7, wherein said collapsing mechanism comprises perforations, score lines, offset material, or combinations thereof in said side walls of said support member.

9. The package of claim 7, wherein said collapsing mechanism comprises a projecting wall area positioned in said base of said support member.

10. The method of claim 7, wherein said product is a fresh meat product.

11. The method of claim 7, wherein said package is a modified atmosphere package.

12. The method of claim 7, further comprising venting said package prior to initiating said collapsing mechanism.

13. A package that enables the on demand blooming of a product, said package comprising:
a. a support member comprising side walls, a base for supporting a product, and a collapsing mechanism; and
b. a lid;
wherein initiating said collapsing mechanism provides product-to-film contact on demand, and
wherein said product-to-film contact enables the product to bloom.

14. The package of claim 13, wherein said collapsing mechanism comprises perforations, score lines, offset material, or combinations thereof in said side walls of said support member.

15. The package of claim 13, wherein said collapsing mechanism comprises a projecting wall area positioned in said base of said support member.

16. The package of claim 13, wherein said product is a fresh meat product.
